(19) United States
(12) Patent Application Publication
(10) Pub. No.: US 2017/0048844 A1
(43) Pub. Date: Feb. 16, 2017

(54) DEVICE, METHOD AND SYSTEM USING THE HE SIG-B FIELD SPATIAL RESOURCE INDICATION

(71) Applicants: Xiaogang Chen, Beijing (CN); Qinghua Li, San Ramon, CA (US); Robert J. Stacey, Portland, OR (US); Huaning Niu, Milpitas, CA (US); Yuan Zhu, Beijing (CN)

(72) Inventors: Xiaogang Chen, Beijing (CN); Qinghua Li, San Ramon, CA (US); Robert J. Stacey, Portland, OR (US); Huaning Niu, Milpitas, CA (US); Yuan Zhu, Beijing (CN)

(21) Appl. No.: 14/977,397

(22) Filed: Dec. 21, 2015

Related U.S. Application Data
(60) Provisional application No. 62/204,086, filed on Aug. 12, 2015.
(60) Provisional application No. 62/204,720, filed on Aug. 13, 2015.

(51) Int. Cl. H04W 72/04; H04W 8/24

(52) U.S. Cl. CPC H04W 72/0413; H04W 8/24; H04W 88/02

(57) ABSTRACT

A STA, AP and method of reducing channel allocation control overhead are disclosed. The STA receives a high-efficiency Physical Layer Convergence Protocol Data Unit (HE PPDU) having a HE SIG-A field followed by a HE SIG-B field. The SIG-B field has user-specific subfields (USS), each having a stream allocation value (SAV) for an associated STA and associated with a unique stream index number (SIN) indicating a position among the USSs. The SINs increase with increasing position from the SIG-B field. The number of channels allocated in each USS is constrained to stay the same or monotonically change with increasing SIN. The STA determines channel allocation from the SAV, SIN and number of USSs. The channels may be allocated non-contiguously. The SAVs in most USSs may indicate an allocation to increasing or decreasing channels and in the final USS to at least one channel starting from a final or initial channel.

### PRIORITY CLAIM

This application claims the benefit of priority to U.S. Provisional Patent Application Ser. No. 62/204,086, filed Aug. 12, 2015, entitled “DEVICE, METHOD AND SYSTEM USING THE HE SIG-B FIELD SPATIAL RESOURCE INDICATION,” and U.S. Provisional Patent Application Ser. No. 62/204,720, filed Aug. 13, 2015, entitled “DEVICE, METHOD AND SYSTEM OPTIMIZATION FOR TRIGGER FRAME RESPONSE WITH NAV CONSIDERATION,” which are incorporated herein by reference in their entirety.

### TECHNICAL FIELD

Embodiments pertain to wireless communications. Some embodiments relate to wireless local area networks (WLANs) and Wi-Fi networks including networks operating in accordance with the IEEE 802.11 family of standards, such as the IEEE 802.11ac standard, the IEEE 802.11ax study group (SG) (named DensiFi) or IEEE 802.11ay. Some embodiments relate to high-efficiency (HE) wireless or high-efficiency WLAN or Wi-Fi (HEW) communications.

### BACKGROUND

A number of different types of communication networks exist to service a wide variety of wireless communication devices. Access points (APs) may provide various IEEE 802.11 communication capabilities for stations (STAs). The communications between the AP and a STA may include high-efficiency (HE) 802.11ax packets that include one or more preambles and user data to deliver Very High Throughput (VHT) OFDMA Multiple Input Multiple Output (MIMO) communications. 802.11ac VHT communications provide a minimum of 500 Mb/s single link and 1 Gb/s overall throughput, running in the 5 GHz band. Both legacy and HE preambles, the latter including an HE signal field (HE-SIG), may be included in communications between an AP and a STA. The HE-SIG field may obey IEEE 802.11 High Efficiency Wireless Local Area Network (WLAN) Study Group formats, in which multiple bits are used to indicate the resource unit allocated to a particular STA.

In the 802.11ax standard, currently undergoing discussion, it would be desirable to provide streamlined information in the HE preamble to aid in communications while maintaining backward compatibility with previous IEEE 802.11 communications.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1 is a functional diagram of a wireless network in accordance with some embodiments.

FIG. 2 illustrates components of a UE in accordance with some embodiments.

FIG. 3 illustrates a block diagram of a communication device in accordance with some embodiments.

FIG. 4 illustrates another block diagram of a communication device in accordance with some embodiments.

FIG. 5 illustrates a HE packet in accordance with some embodiments.

FIG. 6 illustrates a flowchart of packet reception in accordance with some embodiments.

### DETAILED DESCRIPTION OF THE INVENTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

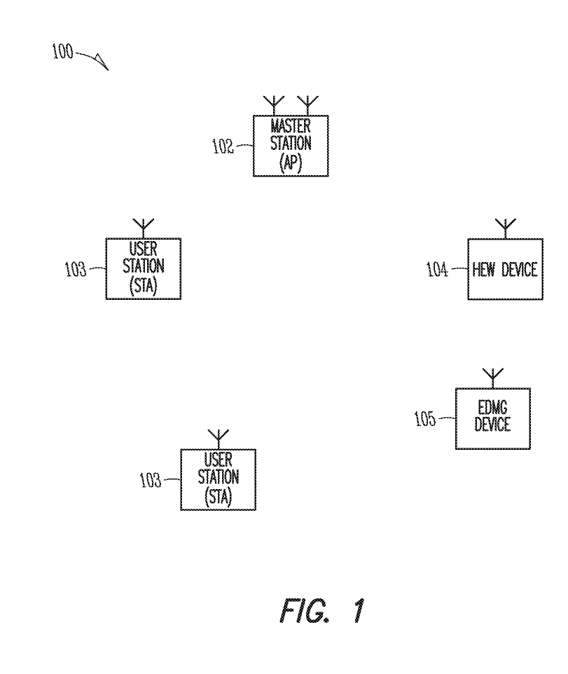

FIG. 1 illustrates a wireless network in accordance with some embodiments. Elements in the network 100 may communicate using the HE prefix, as described herein. In some embodiments, the network 100 may be an Enhanced Directional Multi Gigabit (EDMG) network. In some embodiments, the network 100 may be a High Efficiency Wireless Local Area Network (HEW) network. In some embodiments, the network 100 may be a Wireless Local Area Network (WLAN) or a Wi-Fi network. These embodiments are not limiting, however, as some embodiments of the network 100 may include a combination of such networks. As an example, the network 100 may support EDMG devices in some cases, non EDMG devices in some cases, and a combination of EDMG devices and non EDMG devices in some cases. As another example, the network 100 may support HEW devices in some cases, non HEW devices in some cases, and a combination of HEW devices and non HEW devices in some cases. As another example, some devices supported by the network 100 may be configured to operate according to EDMG operation and/or HEW operation and/or legacy operation. Accordingly, it is understood that although techniques described herein may refer to a non EDMG device, an EDMG device, a non HEW device or an HEW device, such techniques may be applicable to any or all such devices in some cases.

The network 100 may include any number (including zero) of master stations (STA) 102, user stations (STAs) 103, HEW stations 104 (HEW devices), and EDMG stations 105 (EDMG devices). It should be noted that in some embodiments, the master station 102 may be a stationary non-mobile device, such as an access point (AP). In some embodiments, the STAs 103 may be legacy stations. These embodiments are not limiting, however, as the STAs 103 may be HEW devices or may support HEW operation in some embodiments. In some embodiments, the STAs 103 may be EDMG devices or may support EDMG operation. It should be noted that embodiments are not limited to the number of master STAs 102, STAs 103, HEW stations 104 or EDMG stations 105 shown in the example network 100 in FIG. 1. The master station 102 may be arranged to communicate with the STAs 103 and/or the HEW stations 104 and/or the EDMG stations 105 in accordance with one or more of the IEEE 802.11 standards. In accordance with some HEW embodiments, an AP may operate as the master station 102 and may be arranged to contend for a wireless medium (e.g., during a contention period) to receive exclusive control of the medium for an HEW control period (i.e., a transmission opportunity (TXOP)). The master station 102 may, for example, transmit a master-sync or control transmission at the beginning of the HEW control period to indicate, among other things, which HEW stations 104 are scheduled for communication during the HEW control period. During the HEW control period, the scheduled HEW stations 104 may communicate with the master station 102 in accordance with a non-contention based multiple access technique. This is unlike conventional Wi-Fi communications in which devices communicate in accordance with a contention-based communication technique, rather than a non-contention based multiple access technique. During the HEW control period, the master station 102 may communicate with HEW stations 104 using one or more HEW frames. During the HEW control period, STAs 103 not operating as HEW devices may refrain from communicating in some cases. In some embodiments, the master-sync transmission may be referred to as a control and schedule transmission.

In some embodiments, a first STA 103 may transmit a grant frame to a second STA 103 to indicate a transmission of a data payload on primary channel resources or on secondary channel resources. The first STA 103 may receive an acknowledgement message for the grant frame from the second STA 103. The first STA 103 may transmit a data payload to the second STA 103 in the channel resources indicated in the grant frame. These embodiments will be described in more detail below.

In some embodiments, the multiple-access technique used during the HEW control period may be a scheduled orthogonal frequency division multiple access (OFDMA) technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique including a multi-user (MU) multiple-input multiple-output (MIMO) (MU-MIMO) technique. These multiple-access techniques used during the HEW control period may be configured for uplink or downlink data communications.

The master station 102 may also communicate with STAs 103 and/or other legacy stations in accordance with legacy IEEE 802.11 communication techniques. In some embodiments, the master station 102 may also be configurable to communicate with the HEW stations 104 outside the HEW control period in accordance with legacy IEEE 802.11 communication techniques, although this is not a requirement. The master station 102 may form a Basic Service Set (BSS) with the other STAs 103, 104, 105 having a BSSID and communicating using IEEE 802.11 protocols (using an IEEE 802.11a/b/g/n/ac or ax protocol) in a Wireless Local Area Network (WLAN) or Wi-Fi network.

In some embodiments, the HEW communications during the control period may be configurable to use one of 20 MHz, 40 MHz, or 80 MHz contiguous bandwidths or an 80+80 MHz (160 MHz) non-contiguous bandwidth. In some embodiments, a 320 MHz channel width may be used. In some embodiments, subchannel bandwidths less than 20 MHz may also be used. In these embodiments, each channel or subchannel of an HEW communication may be configured for transmitting a number of spatial streams.

In some embodiments, EDMG communication may be configurable to use channel resources that may include one or more frequency bands of 2.16 GHz, 4.32 GHz or other bandwidth. Such channel resources may or may not be contiguous in frequency. As a non-limiting example, EDMG communication may be performed in channel resources at or near a carrier frequency of 60 GHz.

In some embodiments, primary channel resources may include one or more such bandwidths, which may or may not be contiguous in frequency. As a non-limiting example, channel resources spanning a 2.16 GHz or 4.32 GHz bandwidth may be designated as the primary channel resources. As another non-limiting example, channel resources spanning a 20 MHz bandwidth may be designated as the primary channel resources. In some embodiments, secondary channel resources may also be used, which may or may not be contiguous in frequency. As a non-limiting example, the secondary channel resources may include one or more frequency bands of 2.16 GHz bandwidth, 4.32 GHz bandwidth or other bandwidth. As another non-limiting example, the secondary channel resources may include one or more frequency bands of 20 MHz bandwidth or other bandwidth.

In some embodiments, the primary channel resources may be used for transmission of control messages, beacon frames or other frames or signals by the AP 102. As such, the primary channel resources may be at least partly reserved for such transmissions. In some cases, the primary channel resources may also be used for transmission of data payloads and/or other signals. In some embodiments, the transmission of the beacon frames may be restricted such that the AP 102 does not transmit beacons on the secondary channel resources. Accordingly, beacon transmission may be reserved for the primary channel resources and may be restricted and/or prohibited in the secondary channel resources, in some cases.

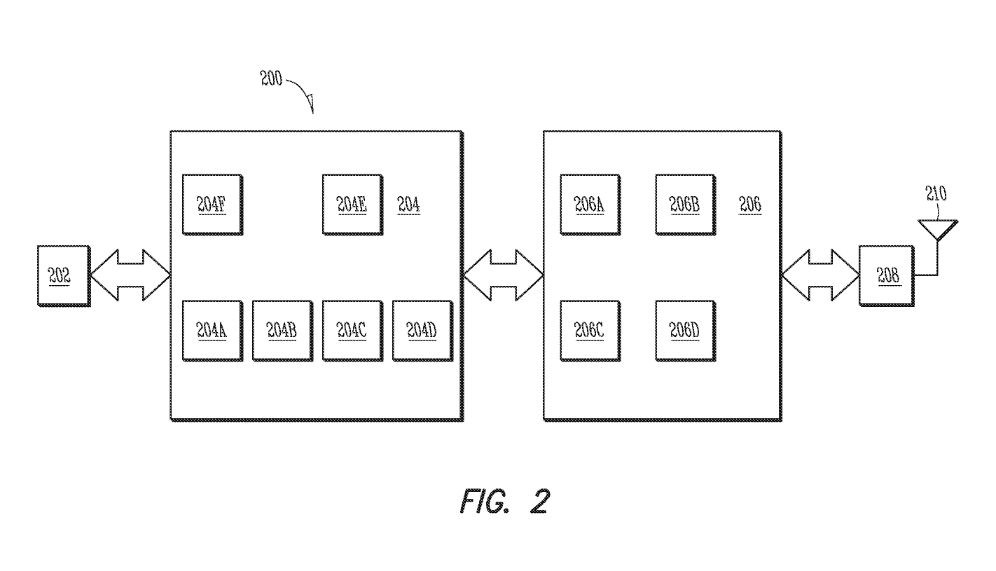

Embodiments described herein may be implemented into a system using any suitably configured hardware and/or software. FIG. 2 illustrates components of a STA in accordance with some embodiments. At least some of the components shown may be used in an AP, for example, such as the STA 102 or AP 104 shown in FIG. 1. The STA 200 and other components may be configured to use the HE prefix as described herein. The application or processing circuitry 202 may include one or more application processors. For example, the application circuitry 202 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 204 may include circuitry such as, but not limited to, one or more single-core or multi-core processors. The baseband circuitry 204 may include one or more baseband processors and/or control logic to process baseband signals received from a receive signal path of the RF circuitry 206 and to generate baseband signals for a transmit signal path of the RF circuitry 206. Baseband processing circuitry 204 may interface with the application circuitry 202 for generation and processing of the baseband signals and for controlling operations of the RF circuitry 206. For example, in some embodiments, the baseband circuitry 204 may include a second generation (2G) baseband processor 204a, third generation (3G) baseband processor 204b, fourth generation (4G) baseband processor 204c, and/or other baseband processor(s) 204d for other existing generations, generations in development or to be developed in the future (e.g., fifth generation (5G), 6G, etc.). The baseband circuitry 204 (e.g., one or more of baseband processors 204a-d) may handle various radio control functions that enable communication with one or more radio networks via the RF circuitry 206. The radio control functions may include, but are not limited to, signal modulation/demodulation, encoding/decoding, radio frequency shifting, etc. In some embodiments, modulation/demodulation circuitry of the baseband circuitry 204 may include Fast-Fourier Transform (FFT), precoding, and/or constellation mapping/demapping functionality. In some embodiments, encoding/decoding circuitry of the baseband circuitry 204 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 204 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 204e of the baseband circuitry 204 may be configured to run elements of the protocol stack for signaling of the PHY, MAC, RLC, PDCP and/or RRC layers. In some embodiments, the baseband circuitry may include one or more audio digital signal processor(s) (DSP) 204f. The audio DSP(s) 204f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 204 and the application circuitry 202 may be implemented together such as, for example, on a system on a chip (SOC).

In some embodiments, the baseband circuitry 204 may provide for communication compatible with one or more radio technologies. For example, in some embodiments, the baseband circuitry 204 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 204 is configured to support radio communications of more than one wireless protocol may be referred to as multi-mode baseband circuitry. In some embodiments, the STA 200 can be configured to operate in accordance with communication standards or other protocols or standards, including Institute of Electrical and Electronic Engineers (IEEE) 802.16 wireless technology (WiMax), IEEE 802.11 wireless technology (WiFi) including 802.11ax, various other wireless technologies such as global system for mobile communications (GSM), enhanced data rates for GSM evolution (EDGE), GSM EDGE radio access network (GERAN), universal mobile telecommunications system (UMTS), UMTS terrestrial radio access network (UTRAN), or other 2G, 3G, 4G, 5G, etc. technologies either already developed or to be developed.

RF circuitry 206 may enable communication with wireless networks using modulated electromagnetic radiation through a non-solid medium. In various embodiments, the RF circuitry 206 may include switches, filters, amplifiers, etc. to facilitate the communication with the wireless network. RF circuitry 206 may include a receive signal path which may include circuitry to down-convert RF signals received from the FEM circuitry 208 and provide baseband signals to the baseband circuitry 204. RF circuitry 206 may also include a transmit signal path which may include circuitry to up-convert baseband signals provided by the baseband circuitry 204 and provide RF output signals to the FEM circuitry 208 for transmission.

In some embodiments, the RF circuitry 206 may include a receive signal path and a transmit signal path. The receive signal path of the RF circuitry 206 may include mixer circuitry 206a, amplifier circuitry 206b and filter circuitry 206c. The transmit signal path of the RF circuitry 206 may include filter circuitry 206c and mixer circuitry 206a. RF circuitry 206 may also include synthesizer circuitry 206d for synthesizing a frequency for use by the mixer circuitry 206a of the receive signal path and the transmit signal path. In some embodiments, the mixer circuitry 206a of the receive signal path may be configured to down-convert RF signals received from the FEM circuitry 208 based on the synthesized frequency provided by synthesizer circuitry 206d. The amplifier circuitry 206b may be configured to amplify the down-converted signals and the filter circuitry 206c may be a low-pass filter (LPF) or band-pass filter (BPF) configured to remove unwanted signals from the down-converted signals to generate output baseband signals. Output baseband signals may be provided to the baseband circuitry 204 for further processing. In some embodiments, the output baseband signals may be zero-frequency baseband signals, although this is not a requirement. In some embodiments, mixer circuitry 206a of the receive signal path may comprise passive mixers, although the scope of the embodiments is not limited in this respect.

In some embodiments, the mixer circuitry 206a of the transmit signal path may be configured to up-convert input baseband signals based on the synthesized frequency provided by the synthesizer circuitry 206d to generate RF output signals for the FEM circuitry 208. The baseband signals may be provided by the baseband circuitry 204 and may be filtered by filter circuitry 206c. The filter circuitry 206c may include a low-pass filter (LPF), although the scope of the embodiments is not limited in this respect.

In some embodiments, the mixer circuitry 206a of the receive signal path and the mixer circuitry 206a of the transmit signal path may include two or more mixers and may be arranged for quadrature downconversion and/or upconversion respectively. In some embodiments, the mixer circuitry 206a of the receive signal path and the mixer circuitry 206a of the transmit signal path may include two or more mixers and may be arranged for image rejection (e.g., Hartley image rejection). In some embodiments, the mixer circuitry 206a of the receive signal path and the mixer circuitry 206a may be arranged for direct downconversion and/or direct upconversion, respectively. In some embodiments, the mixer circuitry 206a of the receive signal path and the mixer circuitry 206a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 206 may include analog-to-digital converter (ADC) and digital-to-analog converter (DAC) circuitry and the baseband circuitry 204 may include a digital baseband interface to communicate with the RF circuitry 206.

In some dual-mode embodiments, a separate radio IC circuitry may be provided for processing signals for each spectrum, although the scope of the embodiments is not limited in this respect.

In some embodiments, the synthesizer circuitry 206d may be a fractional-N synthesizer or a fractional N/N+1 synthesizer, although the scope of the embodiments is not limited in this respect as other types of frequency synthesizers may be suitable. For example, synthesizer circuitry 206d may be a delta-sigma synthesizer, a frequency multiplier, or a synthesizer comprising a phase-locked loop with a frequency divider.

The synthesizer circuitry 206d may be configured to synthesize an output frequency for use by the mixer circuitry 206a of the RF circuitry 206 based on a frequency input and a divider control input. In some embodiments, the synthesizer circuitry 206d may be a fractional N/N+1 synthesizer.

In some embodiments, frequency input may be provided by a voltage controlled oscillator (VCO), although that is not a requirement. Divider control input may be provided by either the baseband circuitry 204 or the applications processor 202 depending on the desired output frequency. In some embodiments, a divider control input (e.g., N) may be determined from a look-up table based on a channel indicated by the applications processor 202.

Synthesizer circuitry 206d of the RF circuitry 206 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 206d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (f_{LO}). In some embodiments, the RF circuitry 206 may include an IQ/polar converter.

FEM circuitry 208 may include a receive signal path which may include circuitry configured to operate on RF signals received from one or more antennas 210, amplify the received signals and provide the amplified versions of the received signals to the RF circuitry 206 for further processing. FEM circuitry 208 may also include a transmit signal path which may include circuitry configured to amplify signals for transmission provided by the RF circuitry 206 for transmission by one or more of the one or more antennas 210.

In some embodiments, the FEM circuitry 208 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 206). The transmit signal path of the FEM circuitry 208 may include a power amplifier (PA) to amplify input RF signals (e.g., provided by RF circuitry 206), and one or more filters to generate RF signals for subsequent transmission (e.g., by one or more of the one or more antennas 210.

In some embodiments, the STA 200 may include additional elements such as, for example, memory/storage, display, camera, sensor, and/or input/output (I/O) interface as described in more detail below. In some embodiments, the STA 200 described herein may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), or other device that may receive and/or transmit information wirelessly. In some embodiments, the STA 200 may include one or more user interfaces designed to enable user interaction with the system and/or peripheral component interfaces designed to enable peripheral component interaction with the system. For example, the STA 200 may include one or more of a keyboard, a keypad, a touchpad, a display, a sensor, a non-volatile memory port, a universal serial bus (USB) port, an audio jack, a power supply interface, one or more antennas, a graphics processor, an application processor, a speaker, a microphone, and other I/O components. The display may be an LCD or LED screen including a touch screen. The sensor may include a gyro sensor, an accelerometer, a proximity sensor, an ambient light sensor, and a positioning unit. The positioning unit may communicate with components of a positioning network, e.g., a global positioning system (GPS) satellite.

The antenna 210 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 210 may be effectively separated to take advantage of spatial diversity and the different channel characteristics that may result.

Although the STA 200 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

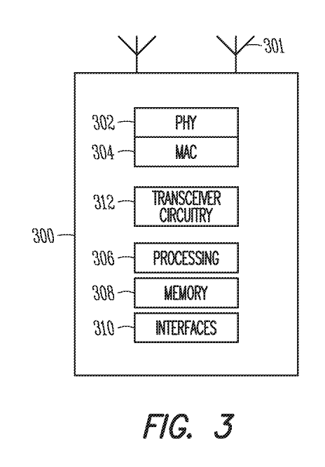

FIG. 3 is a block diagram of a communication device in accordance with some embodiments. The device may be a STA or AP, for example, such as the STA 102 or AP 104 shown in FIG. 1. The communication device 300 may include physical layer circuitry 302 and transceiver circuitry 312 for transmitting and receiving signals to and from one or more APs, STAs or other devices using one or more antennas 301. The communication device 300 may also include medium access control layer (MAC) circuitry 304 for controlling access to the wireless medium. The communication device 300 may also include processing circuitry 306, such as one or more single-core or multi-core processors, and memory 308 arranged to perform the operations described herein. The communication device 300 may also include wired and/or wireless interfaces 310 to communicate with components external to the network. The physical layer circuitry 302, MAC circuitry 304 and processing circuitry 306 may handle various radio control functions that enable communication with one or more radio networks compatible with one or more radio technologies. The radio control functions may include signal modulation, encoding, decoding, radio frequency shifting, etc. For example, similar to the device shown in FIG. 2, in some embodiments, communication may be enabled with one or more of a WMAN, a WLAN, and a WPAN. In some embodiments, the communication device 300 can be configured to operate in accordance with 3GPP standards or other protocols or standards, including WiMax, WiFi, GSM, EDGE, GERAN, UMTS, UTRAN, or other 3G, 3G, 4G, 5G, etc. technologies either already developed or to be developed. The physical layer circuitry 202, MAC layer circuitry 304, transceiver circuitry 312, processing circuitry 308, memory 308 and interfaces 310 may be separate components or may be part of a combined component.

The antennas 301 may comprise one or more directional or omnidirectional antennas, including, for example, dipole antennas, monopole antennas, patch antennas, loop antennas, microstrip antennas or other types of antennas suitable for transmission of RF signals. In some MIMO embodiments, the antennas 301 may be effectively separated to take advantage of spatial diversity and the different channel characteristics that may result.

Although the communication device 300 is illustrated as having several separate functional elements, one or more of the functional elements may be combined and may be implemented by combinations of software-configured elements, such as processing elements including DSPs, and/or other hardware elements. For example, some elements may comprise one or more microprocessors, DSPs, FPGAs, ASICs, RFICs and combinations of various hardware and logic circuitry for performing at least the functions described herein. In some embodiments, the functional elements may refer to one or more processes operating on one or more processing elements. Embodiments may be implemented in one or a combination of hardware, firmware and software. Embodiments may also be implemented as instructions stored on a computer-readable storage device, which may be read and executed by at least one processor to perform the operations described herein.

In some embodiments, the communication device 300 may be a mobile device and may be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive and/or transmit information wirelessly.

In some embodiments, the communication device 300 may communicate using OFDM communication signals over a multicarrier communication channel. Accordingly, in some cases the communication device 300 may be configured to receive signals in accordance with specific communication standards, such as the Institute of Electrical and Electronics Engineers (IEEE) standards including IEEE 802.11-2012, 802.11n-2009 and/or 802.11ac-2013 standards and/or proposed specifications for WLANs including proposed HEW standards, although the scope of the invention is not limited in this respect as they may also be suitable to transmit and/or receive communications in accordance with other techniques and standards. In some other embodiments, the communication device 300 may be configured to receive signals that were transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In accordance with embodiments, the communication device 300 may transmit an SM-OFDM signal that comprises multiple OFDM signals, and the SM-OFDM signal may be received at the communication device 300. The SM-OFDM signal may be transmitted in channel resources that comprise multiple sub-carriers and the OFDM signals may be based at least partly on data symbols for used data portions of the sub-carriers. The used data portions may be based on a first portion of encoded bits and the data symbols for the used data portions may be based on a second portion of the encoded bits. In some examples, the used data portions of the sub-carriers may be different for at least some of the OFDM signals.

In some embodiments, the channel resources may be used for downlink transmission and for uplink transmissions by the communication device 300. That is, a time-division duplex (TDD) format may be used. In some cases, the channel resources may include multiple channels, such as the 20 MHz channels previously described. The channels may include multiple sub-channels or may be divided into multiple sub-channels for the uplink transmissions to accommodate multiple access for multiple communication devices 300. The downlink transmissions may or may not utilize the same format.

In some embodiments, the downlink sub-channels may comprise a predetermined bandwidth. As a non-limiting example, the sub-channels may each span 2.03125 MHz, the channel may span 20 MHz, and the channel may include eight or nine sub-channels. Although reference may be made to a sub-channel of 2.03125 MHz for illustrative purposes, embodiments are not limited to this example value, and any suitable frequency span for the sub-channels may be used. In some embodiments, the frequency span for the sub-channel may be based on a value included in an 802.11 standard (such as 802.11ax), a 3GPP standard or other standard.

In some embodiments, the sub-channels may comprise multiple sub-carriers. Although not limited as such, the sub-carriers may be used for transmission and/or reception of OFDM or OFDMA signals. As an example, each sub-channel may include a group of contiguous sub-carriers spaced apart by a pre-determined sub-carrier spacing. As another example, each sub-channel may include a group of non-contiguous sub-carriers. That is, the channel may be divided into a set of contiguous sub-carriers spaced apart by the pre-determined sub-carrier spacing, and each sub-channel may include a distributed or interleaved subset of those sub-carriers. The sub-carrier spacing may take a value such as 78.125 kHz, 312.5 kHz or 15 kHz, although these example values are not limiting. Other suitable values that may or may not be part of an 802.11 or 3GPP standard or other standard may also be used in some cases. As an example, for a 78.125 kHz sub-carrier spacing, a sub-channel may comprise 26 contiguous sub-carriers or a bandwidth of 2.03125 MHz.

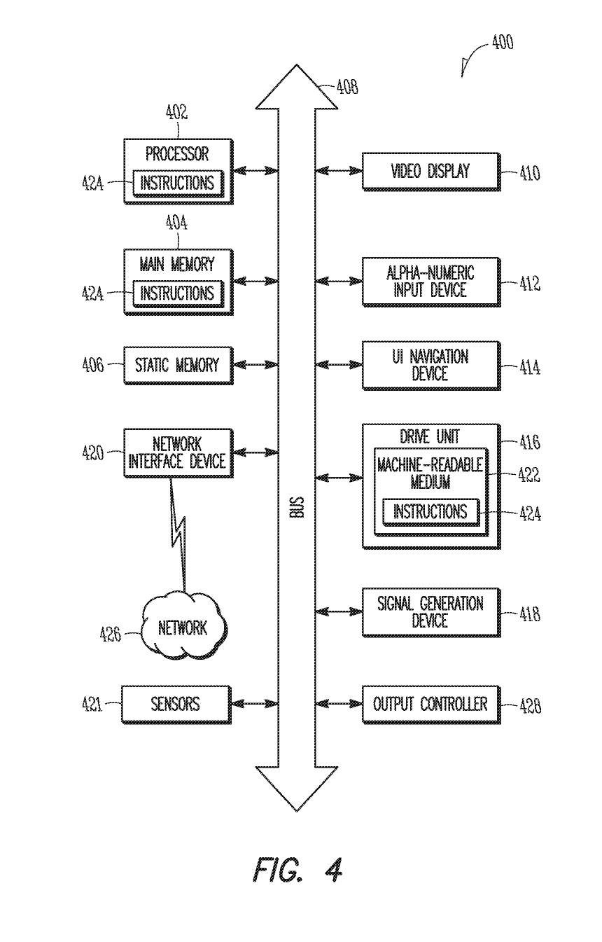

FIG. 4 illustrates another block diagram of a communication device in accordance with some embodiments. In alternative embodiments, the communication device 400 may operate as a standalone device or may be connected (e.g., networked) to other communication devices. In a networked deployment, the communication device 400 may operate in the capacity of a server communication device, a client communication device, or both in server-client network environments. In an example, the communication device 400 may act as a peer communication device in peer-to-peer (P2P) (or other distributed) network environment. The communication device 400 may be an AP or a STA such as a PC, a tablet PC, a STB, a PDA, a mobile telephone, a smart phone, a web appliance, a network router, switch or bridge, or any communication device capable of executing instructions (sequential or otherwise) that specify actions to be taken by that communication device. Further, while only a single communication device is illustrated, the term “communication device” shall also be taken to include any collection of communication devices that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a communication device readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Communication device (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The communication device 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The communication device 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The communication device 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a communication device readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the communication device 400. In an example, one or any combination of the hardware processor 402, the main memory 404, the static memory 406, or the storage device 416 may constitute communication device readable media.

While the communication device readable medium 422 is illustrated as a single medium, the term “communication device readable medium” may include a single medium or multiple media (e.g., a centralized or distributed database, and/or associated caches and servers) configured to store the one or more instructions 424.

The term “communication device readable medium” may include any medium that is capable of storing, encoding, or carrying instructions for execution by the communication device 400 and that cause the communication device 400 to perform any one or more of the techniques of the present disclosure, or that is capable of storing, encoding or carrying data structures used by or associated with such instructions. Non-limiting communication device readable medium examples may include solid-state memories, and optical and magnetic media. Specific examples of communication device readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, communication device readable media may include non-transitory communication device readable media. In some examples, communication device readable media may include communication device readable media that is not a transitory propagating signal.

The instructions 424 may further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., IEEE 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), MIMO, or multiple-input single-output (MISO) techniques. In some examples, the network interface device 420 may wirelessly communicate using Multiple User MIMO techniques. The term “transmission medium” shall be taken to include any intangible medium that is capable of storing, encoding or carrying instructions for execution by the communication device 400, and includes digital or analog communications signals or other intangible medium to facilitate communication of such software.

The communication devices shown in FIGS. 1-4 may, as above, use MIMO transmissions in data communication within the network. To enable multi-user MIMO transmissions, the 802.11 preamble may describe a number of spatial streams and enable each STA in the BSS to communicate using the desired stream. A Physical Layer Convergence Protocol (PLCP) of 802.11 communications defines a PLCP Protocol Data Unit (PPDU). The fields of the physical layer frame of legacy (up to 802.11ac) transmissions may include a two symbol Non-HT Short Training Field (L-STF) and a two symbol Non-HT Long Training Field (L-LTF), a one symbol Non-HT Signal Field (L-SIG), two symbol VHT Signal A (VHT-SIG-A) and Signal B (VHT-SIG-B) Fields, a one symbol VHT Short Training Field (VHT-STF), a VHT Long Training Field (VHT-LTF), and a Data Field. The Non-HT Short Training Field (L-STF) and Non-HT Long Training Field (L-LTF) may contain OFDM symbols used to assist a STA in identifying that an 802.11 frame is about to start, synchronizing timers, and selecting an antenna. The L-STF and L-LTF may be transmitted for backwards compatibility with previous versions of 802.11 and duplicated over each 20 MHz subband with phase rotation. The L-SIG may be used to describe the data rate and length (in bytes) of the frame, which is used by STAs to calculate the time duration of the frame's transmission. The VHT-SIG-A and VHT-SIG-B may have one symbol transmitted in BPSK and a second in QBPSK and may describe the included frame attributes such as the channel width, modulation and coding, and whether the frame is a single- or multi-user frame. The VHT-STF may be used to assist a STA in detecting a repeating pattern and setting receiver gain. The VHT-LTF may be used to set up demodulation of the rest of the frame, starting with the VHT Signal B field, and may be used for channel estimation. Depending on the number of transmitted streams, the VHT-LTF may contain 1, 2, 4, 6, or 8 symbols; the number of symbols is rounded up to the next highest value, so a link with five streams would use six symbols. The data field may contain a higher-layer protocol packet, an aggregate frame containing multiple higher-layer packets, or, is used by the VHT PHY for beamforming setup, measurement, and tuning if no Data field is present in the physical layer payload.

The signal fields (SIG-A and SIG-B) may help the STA decode the data payload, which may be done by describing the parameters used for transmission. The SIG-A field may be a common field and thus received identically by all receivers, while the SIG-B field may be unique to each STA. The SIG-A field may include, among others, information about the channel bandwidth, a Group ID enabling a STA to determine whether the data payload is single- or multi-user, the modulation and coding scheme (MCS), etc. . . . . The VHT SIG-B field may be used to set up the data rate, as well as tune in MIMO reception. The VHT SIG-B field may be transmitted in a single OFDM symbol, so that different lengths (26, 27 or 29 bits) may be used depending on the channel width. This field may vary in size so that the maximum value of the field is approximately constant. Reserved bits (2 or 3 bits) between the length field and the tail are reserved, and Tail bits (6 bits) that may allow a convolutional coder to complete.

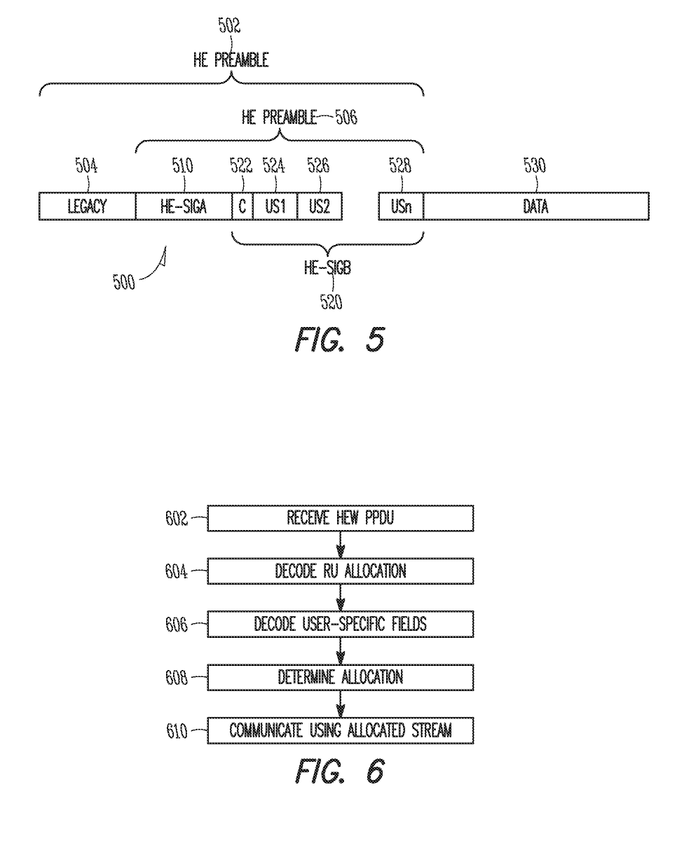

In accordance with IEEE 802.11ax embodiments, a master station 102 and/or HEW stations 104 may generate a HEW PPDU in accordance with a short preamble format or a long preamble format. FIG. 5 illustrates a HE packet in accordance with some embodiments. The bandwidth for 802.11ax transmissions may be divided into 20 MHz channels. Each channel may be a single user (SU), multiuser MIMO (MU-MIMO) or OFDMA transmission.

The HEW PPDU 500 may have a preamble 502 that contains a legacy preamble 504 (L-STF, L-LTF and L-SIG) followed by a HE preamble 506. The preamble 502 may be followed by data 530. The legacy preamble 504 may contain fields that allow compatibility with non-HEW devices. The legacy preamble 504 may be duplicated on each of the 20 MHz channels for backward compatibility with legacy devices. The L-STF, the L-LTF, and the L-SIG (not shown in FIG. 5 for convenience) may be transmitted in an Orthogonal Frequency Division Multiplexing (OFDM) symbol generated based on 64 Fast Fourier Transform (FFT) points (or 64 subcarriers) in each 20 MHz channel. The HE preamble 506 may contain one or more high-efficiency (HE) signal fields, referred to as the HE SIG-A field 510 and the HE SIG-B field 520. The HE preamble 506 may allow HEW-specific information to be exchanged between, for example, an AP and one or more STA that may be HEW devices.

The HE signal fields, 510, 520 may replace the legacy VHT-SIG fields and an HE long-training field (HE-LTF). The HE SIG-A field 510 may provide common control information in two or three OFDM symbols. The HE SIG-A field 510 may include information used to decode the HE SIG-B field 520. The common control information may include a 2 bit PPDU bandwidth (e.g., 20 MHz, 40 MHz, 80 MHz or 160 MHz), a 6 bit group ID indicating an STA or a group of STAs that will receive the PPDU, 12 bit stream information indicating the number or location of spatial streams for each STA or the number or location of spatial streams for a group of STAs (also referred to herein as a resource allocation (RU)), a 1 bit uplink indication indicating whether the PPDU is to an AP (uplink) or to an STA (downlink), a 1 bit multi-user (MU) indication indicating whether the PPDU is an SU-MIMO PPDU or an MU-MIMO PPDU, a 1 bit guard interval indication indicating whether a short or long guard interval is used, 12 bit allocation information indicating a band or a channel (subchannel index or subband index) allocated to each STA in a bandwidth in which the PPDU is transmitted, and 12 bit transmission power indicating the transmission power for each channel or each STA. Spatial stream allocation may be used to allocate spatial streams for transmissions in multiuser (MU) multiple-input multiple-output (MIMO) systems. The HE SIG-A field 510 may thus contain signaling that indicates whether OFDMA or MU MIMO transmission is used in the current PPDU.

The HE SIG-B field 520 may include information specific to each STA, but may be encoded over the entire band and thus may be received by all STAs in the BSS. The HE SIG-B field 520 may include a common field 522 followed by multiple user-specific subfields 524, 526, 528, each of which may be for a different designated receiving STA. The common field 522 of the HE SIG-B field 520 may include information for all designated STAs to receive the PPDU in the corresponding bandwidth. The common field 522 may have, in some embodiments, a fixed length subfield and a variable length subfield. The fixed length subfield may contain information about frequency bandwidth allocation indicating allocation of the resource in the frequency domain. After the fixed length subfield is decoded, the length of the variable length subfield may be calculated for channel decoding to enable STA to determine how to decode other subfields that may be received. In some embodiments, the variable length subfield may contain a spatial stream allocation for each of the allocated RUs or may be provided in the user specific portion of the HE SIG-B field 520.

The HE SIG-B field 520 may have one or two OFDM symbols and include information for each STA to interpret the HE MU PPDU 500. The HE SIG-B field 520 may include, for example, information about the length of a corresponding PSDU and the MCS of the corresponding PSDU. The HE SIG-B field 520 may have the same position as the legacy VHT-SIG-B field or may have a different position. In some embodiments, the HE SIG-B field 520 may have a variable length and be an extension of the HE SIG-A field 510. The boundary between the common field 522 and the user-specific subfields 524, 526, 528 may be at the bit-level, rather than the OFDM symbol boundary.

The IEEE 802.11ax communications may focus on high density deployment scenarios in which a multitude of low-cost, low complexity STAs such as Machine-Type Communication (MTC) STAs of the Internet of Things (IoT) proximate to each other are served by one or more APs. IEEE 802.11 ax may thus desire to increase throughput in such scenarios with improved power efficiency for battery powered devices. To this end, it may be desirable to reduce the number of bits used in the PPDU, in particular when MIMO communications are used.

In some embodiments, the number of bits used in the HE SIG-B field 520 may be reduced. Specifically, the common field in the HE SIG-B field 520 may contain a RU allocation to indicate the resource in the user-specific subfield 524, 526, 528. While 4 bits may be employed per STA to signal individual spatial streams in MIMO communications in which each STA communicates with the AP via one or more streams, it may be desirable to reduce the overhead associated with providing the signaling information. In some embodiments, when the number of allocated STAs in each RU are signaled in the common part 522 of the HE SIG-B field 520, the spatial stream indication in the user-specific subfield 524, 526, 528 of the HE SIG-B field 520 may be adjusted to save one bit and employ 3 bits/user.

Specifically, each STA may decode every user-specific subfield to determine whether the user-specific subfield includes information for that STA. The user-specific subfield may be encoded using an ID of the STA and thus be inaccessible to other STAs in the BSS. Thus, a change in the order of STAs in the user-specific subfield 524, 526, 528 may not impact the detection procedure and performance but may serve to provide additional information. In some embodiments, the ordering of allocated streams for STAs in one RU may be predetermined or constrained and based on the number of allocated streams. Specifically, in some embodiments when multiple streams are allocated in one RU, the order number of allocated streams for STAs in one RU may be provided in an increasing or decreasing pattern.

Thus, if n STAs are allocated in one RU, an increasing number of Nsts means N_{sts-STA1}<N_{sts-STA2}< . . . <N_{sts-STAn}, where N_{sts-STAi} stands for the Nₛₜₛ for the i^{th} STA. For example, if 8 streams are provided by the AP and 3 STAs are receiving the streams, the streams allocated may be provided in increasing order such that the number of streams (Nₛₜₛ) allocated to STA₁ (N_{sts-STA1})≦N_{sts-STA2}≦N_{sts-STA3}. Without loss of generality, the increasing order is used hereafter for further explanations, with the understanding that decreasing order may also be used. Knowing the number of streams, the number of STAs and the placement within the allocation may permit each STA to determine which streams to use by decoding the 3 bits associated with the STA. In such an embodiment, not all of the streams may be allocated, in which case non-contiguous stream allocation may be used.

In one example, given the maximum number of streams in one RU is 8 (N_{LTF}=8) and the number of allocated STAs in one RU is Nᵤₛₑᵣ, Table 1 through Table 8, which may be stored in a memory of the STAs and AP, list stream allocation indexes for N_{LTF}=8 and Nᵤₛₑᵣ=1, 2, 3, 4, 5, 6, 7, 8 respectively. StreamIdx_i indicates allocation order (the position within the user-specific subfields that contains the stream allocation for the STA), and the stream index candidates indicate the possible stream allocations, for the i^{th} STA.

TABLE 1
Nᵤₛₑᵣ = 1, N_{LTF} = 8

| | StreamIdx_1 |
|---|---|
| Stream index | 1, 1~2, 1~3, 1~4, 1~5, |
| candidates | 1~6, 1~7, 1~8 |
| Number of | 8 |
| entries | |
| (N_{LTF} = 8) | |

TABLE 2
Nᵤₛₑᵣ = 2, N_{LTF} =8

| | StreamIdx_1 | StreamIdx_2 |
|---|---|---|
| Stream index | 1, 1~2, 1~3, 1~4 | 8, 7~8, 6~8, 5~8, |
| candidates | | 4~8, 3~8, 2~8 |
| Number of | 4 | 7 |
| entries | | |
| (N_{LTF} = 8) | | |

TABLE 3
Nᵤₛₑᵣ = 3, N_{LTF} = 8

| | StreamIdx_1 | StreamIdx_2 | StreamIdx_3 |
|---|---|---|---|
| Stream index | 1, 1~2 | 2, 2~3, 2~4, | 8, 7~8, 6~8, |
| candidates | | 3~4, 3~5 | 5~8, 4~8, 3~8 |
| Number of entries | 2 | 5 | 6 |
| (N_{LTF} = 8) | | | |

TABLE 4
Nᵤₛₑᵣ = 4, N_{LTF} = 8

| | StreamIdx_1 | StreamIdx_2 | StreamIdx_3 | StreamIdx_4 |
|---|---|---|---|---|
| Stream index candidates | 1, 1~2 | 2, 2~3, 3~4 | 3, 3~4, 3~5, 4~5, 5~6 | 8, 7~8, 6~8, 5~8, 4~8 |
| Number of entries (N_{LTF} = 8) | 2 | 3 | 5 | 5 |

TABLE 5
Nᵤₛₑᵣ = 5, N_{LTF} = 8

| | StreamIdx_1 | StreamIdx_2 | StreamIdx_3 | StreamIdx_4 | StreamIdx_5 |
|---|---|---|---|---|---|
| Stream index candidates | 1 | 2 | 3 | 4, 4~5 | 8, 7~8, 6~8, 5~8 |
| Number of entries (N_{LTF} = 8) | 1 | 1 | 1 | 2 | 4 |

TABLE 6
Nᵤₛₑᵣ = 6, N_{LTF} = 8

| | StreamIdx_1 | StreamIdx_2 | StreamIdx_3 | StreamIdx_4 | StreamIdx_5 | StreamIdx_6 |
|---|---|---|---|---|---|---|
| Stream index | 1 | 2 | 3 | 4 | 5, 5~6 | 8, 7~8, 6~8 |
| candidates | | | | | | |
| Number of | 1 | 1 | 1 | 1 | 2 | 3 |
| entries | | | | | | |
| (N_{LTF} = 8) | | | | | | |

TABLE 7
Nᵤₛₑᵣ = 7, N_{LTF} = 8

| | StreamIdx_1 | StreamIdx_2 | StreamIdx_3 | StreamIdx_4 | StreamIdx_5 | StreamIdx_6 | StreamIdx_7 |
|---|---|---|---|---|---|---|---|
| Stream index | 1 | 2 | 3 | 4 | 5 | 6 | 8, 7~8, |
| candidates | | | | | | | |
| Number of | 1 | 1 | 1 | 1 | 1 | 1 | 2 |
| entries | | | | | | | |
| (N_{LTF} = 8) | | | | | | | |

TABLE 8
Nᵤₛₑᵣ = 8, N_{LTF} = 8

| | StreamIdx_1 | StreamIdx_2 | StreamIdx_3 | StreamIdx_4 | StreamIdx_5 | StreamIdx_6 | StreamIdx_7 | StreamIdx_8 |
|---|---|---|---|---|---|---|---|---|
| Stream index | 1 | 2 | 3 | 4 | 5 | 6 | 7 | 8 |
| candidates | | | | | | | | |
| Number of | 1 | 1 | 1 | 1 | 1 | 1 | 1 | 1 |
| entries | | | | | | | | |
| (N_{LTF} = 8) | | | | | | | | |

Taking Table 3, for example, 3 STAs receive streams. Because there are a maximum of 8 streams, STA1 (i.e., the STA associated with streamindex_1) may only receive 1 or 2 streams as any greater number of streams would result in the ordering no longer increasing in number of streams. For example, if STA1 receives 3 streams, either STA2 or STA3 would have to receive either 1 or 2 streams (e.g., N_{sts-STA2}=2 streams and N_{sts-STA3}=3 streams=8 streams total), in violation of the increasing number constraint. STA2 may receive 1, 2 or 3 streams (index 2, 2 and 3, or 2, 3 and 4) if STA1 receives 1 stream (index 1), and STA2 may receive 2 or 3 streams (index 3 and 4, or 3, 4 and 5) if STA1 receives 2 streams (index 1 and 2). Thus, the number of entries (different combinations) for STA1 is 2: index 1 or index 1 and 2; the number of entries for STA2 is 5: 3 if STA1 receives 1 stream (index 2, 2 and 3, or 2, 3 and 4=3) plus 2 if STA1 receives 2 streams (index 3 and 4, or 3, 4 and 5=2). Similarly, STA3 may have 6 entries/unique combinations and STA3 may receive 1 to 6 streams (index 8, 8 and 7, 8, 7, and 6, . . . index 8, 7, 6, 5, 4, 3) if STA1 and STA2 receive 1 stream (index 1 and 2 respectively). As shown by Table 1, the maximum number of entries is 8, and thus 3 bits may be used to indicate the entry for a particular STA. For example, the STA may determine from the common portion of HE SIG-B (or the HE SIG-A) that the total number of RUs is 3 and that the stream. In some embodiments, the RU allocation, i.e., the channel allocation, may thus be based on a largest stream index number in the HE SIG-B field. The RU allocation may be determined from the information in the HE-SIGA or common subfield of the HE-SIGB. In some embodiments, the channel allocation may be based on a total number of user-specific subfields in the HE SIG-B field. In some embodiments, the stream index number and total number of user-specific subfields in the HE SIG-B field may be the same.

In some embodiments, the streams may be contiguously allocated. This is to say that if 8 streams are available but only 6 streams are allocated to various STAs, the first or last streams (i.e., stream index 7 and 8, 1 and 2, or 1 and 8) may remain vacant. However, in some embodiments, as evidenced by the aforementioned tables, non-contiguous stream allocation is permitted. For instance, the AP may wish to assign 4 STAs in the current RU, with the number of allocated streams for each STA respectively N_{sts-STA1}=1; N_{sts-STA2}=1; N_{sts-STA3}=1; N_{sts-STA4}=2. Based on Table 4, the stream indexes for STA1/STA2/STA3/STA4 may respectively be 1/2/3/7-8. In this case, streams 4-6 may not be used.

In some embodiments, using non-contiguous stream allocation, the last STA may always be allocated to stream Nᵤₛₑᵣ+i˜N_{LTF}, i=0, 1, . . . , N_{LTF}-Nᵤₛₑᵣ. The streams for the remaining STAs may be ordered according to an increasing number of the allocated stream based on the corresponding table. Non-contiguous stream allocation may be able to save on signaling overhead as the streams of the last STA may be indexed from the last stream. This is to say that a reference to start the indexing for the last STA exists and thus the last STA does not consider how many streams are used by the other STAs. If only contiguous stream allocation is used, the reference used to start the indexing for the last STA may change depending on the number of streams used by the other STAs.

In other embodiments, the STAs may be ordered with a decreasing number of allocated streams with slight modification of the above tables. In one example, the column index of Table 2 is shifted if two STAs are allocated (assuming the STAs are ordered with decreasing number of allocated streams) as shown in Table 9. Thus, as shown, the stream index of STA1, which has a larger number of entries than that of STA2, occurs after the stream index of STA2 in the HE SIG-B field 520.

TABLE 9
Nᵤₛₑᵣ = 2, N_{LTF} = 8 (decreasing)

| | StreamIdx_2 | StreamIdx_1 |
|---|---|---|
| Stream index candidates | 1, 1~2, 1~3, 1~4 | 8, 7~8, 6~8, 5~8, |
| | | 4~8, 3~8, 2~8 |
| Number of entries (N_{LTF} = 8) | 4 | 7 |

If the maximum number of streams in one RU is less than 8, e.g. 2, 4 or 6, the stream allocation tables may be able to be generated following the same rule as Tables 1-8. Tables 10-15 list the stream allocation indexes for N_{LTF}=6 and Nᵤₛₑᵣ=1, 2, 3, 4, 5, 6 respectively.

TABLE 10
Nᵤₛₑᵣ = 1, N_{LTF} = 6

| | StreamIdx_1 |
|---|---|
| Stream index candidates | 1, 1~2, 1~3, 1~4, 1~5, 1~6 |
| Max number of entries (N_{LTF} = 6) | 6 |

TABLE 11
Nᵤₛₑᵣ = 2, N_{LTF} = 6

| | StreamIdx_1 | StreamIdx_2 |
|---|---|---|
| Stream index candidates | 1, 1~2, 1~3 | 6, 5~6, 4~6, 3~6, 2~6 |
| Max number of entries | 3 | 5 |
| (N_{LTF} = 6) | | |

TABLE 12
Nᵤₛₑᵣ = 3, N_{LTF} = 6

| | StreamIdx_1 | StreamIdx_2 | StreamIdx_3 |
|---|---|---|---|
| Stream index | 1, 1~2 | 2, 2~3, 2~4, 3~4 | 6, 5~6, 4~6, 3~6 |
| candidates | | | |
| Max number | 2 | 4 | 4 |
| of entries | | | |
| (N_{LTF} = 6) | | | |

TABLE 13
Nᵤₛₑᵣ = 4, N_{LTF} = 6

| | StreamIdx_1 | StreamIdx_2 | StreamIdx_3 | StreamIdx_4 |
|---|---|---|---|---|
| Stream index candidates | 1 | 2 | 3, 3~4 | 6, 5~6, 4~6 |
| Max number of entries (N_{LTF} = 6) | 1 | 1 | 2 | 3 |

TABLE 14
Nᵤₛₑᵣ = 5, N_{LTF} = 6

| | StreamIdx_1 | StreamIdx_2 | StreamIdx_3 | StreamIdx_4 | StreamIdx_5 |
|---|---|---|---|---|---|
| Stream index candidates | 1 | 2 | 3 | 4 | 6, 5~6 |
| Max number of entries (N_{LTF} = 6) | 1 | 1 | 1 | 1 | 2 |

TABLE 15
Nᵤₛₑᵣ = 6, N_{LTF} = 6

| | StreamIdx_1 | StreamIdx_2 | StreamIdx_3 | StreamIdx_4 | StreamIdx_5 | StreamIdx_6 |
|---|---|---|---|---|---|---|
| Stream index | 1 | 2 | 3 | 4 | 5 | 6 |
| candidates | | | | | | |
| Max number | 1 | 1 | 1 | 1 | 1 | 1 |
| of entries | | | | | | |
| (N_{LTF} = 6) | | | | | | |

TABLE 16
Nᵤₛₑᵣ = 1, N_{LTF} = 4

| | StreamIdx_1 |
|---|---|
| Stream index candidates | 1, 1~2, 1~3, 1~4 |
| Max number of entries (N_{LTF} = 4) | 4 |

Table 16-table 19 list the stream allocation indexes for N_{LTF}=4 and Nᵤₛₑᵣ=1,2,3,4 respectively.

TABLE 17
Nᵤₛₑᵣ = 2, N_{LTF} = 4

| | StreamIdx_1 | StreamIdx_2 |
|---|---|---|
| Stream index candidates | 1, 1~2 | 4, 3~4, 2~4 |
| Max number of entries (N_{LTF} = 4) | 2 | 3 |

TABLE 18
Nᵤₛₑᵣ = 3, N_{LTF} = 4

| | StreamIdx_1 | StreamIdx_2 | StreamIdx_3 |
|---|---|---|---|
| Stream index | 1 | 2 | 4, 3~4 |
| candidates | | | |
| Max number of entries | 1 | 1 | 2 |
| (N_{LTF} = 4) | | | |

TABLE 19
Nᵤₛₑᵣ = 4, N_{LTF} = 4

| | StreamIdx_1 | StreamIdx_2 | StreamIdx_3 | StreamIdx_4 |
|---|---|---|---|---|
| Stream index candidates | 1 | 2 | 3 | 4 |
| Max number of entries (N_{LTF} = 4) | 1 | 1 | 1 | 1 |

Table 20-table 21 list the stream allocation indexes for N_{LTF}=2 and Nᵤₛₑᵣ=1,2 respectively.

TABLE 20
Nᵤₛₑᵣ = 1, N_{LTF} = 2

| | StreamIdx_1 |
|---|---|
| Stream index candidates | 1, 1~2 |
| Max number of entries (N_{LTF} = 2) | 2 |

TABLE 21
Nᵤₛₑᵣ = 2, N_{LTF} = 2

| | StreamIdx_1 | StreamIdx_2 |
|---|---|---|
| Stream index candidates | 1 | 2 |
| Max number of entries (N_{LTF} = 2) | 1 | 1 |

FIG. 6 illustrates a flowchart of packet reception in accordance with some embodiments. The communication may occur between an AP and STA, such as those shown in any of FIGS. 1-4. At operation 602, the STA may receive from the AP a HEW PPDU. The HEW PPDU may contain a legacy preamble, a HE preamble and data.

The HE preamble may contain the HE SIG-A field, which is common to all STAs, and a user-specific the HE SIG-B field. The HE SIG-A field may include information including the total bandwidth/available subchannels. The HE SIG-B field may, in turn, contain a common field that may include an RU allocation having an allocation pattern index to be used by one or more STA in the BSS. Once the total bandwidth or the available subchannels are known from the HE SIG-A field, the number of bits in the RU allocation may be known. The RU allocation may be protected by a channel code word encoded together with the rest of the common field. Since the length of the RU allocation may be known, the STA may at operation 604 decode the RU allocation so that the number, sizes and locations of all the available RUs in the band may be determined by the STA. The spatial stream allocation for each available RU may be specified in the user specific portions of the HE SIG-B field following the RU allocation. In some embodiments, a bitmap for the RUs may be disposed after the RU allocation and before the spatial stream allocation.

The STA may continue at operation 606 to decode the spatial stream allocations in every user-specific subfield to determine whether any user-specific subfield includes information for that STA. The encoding for each user-specific subfield may be specific to the STA to which the user-specific subfield is directed such that only that STA may be able to decode the user-specific subfield. After decoding a particular user-specific subfield at operation 606, the STA may extract the stream allocation value contained therein.

Once the STA has obtained the stream allocation value, the STA may at operation 608 determine the stream allocation using a lookup table stored in a memory of the STA. The STA may also determine its stream index number (i.e., order of the stream allocation). The STA may use the lookup table based on the number of RUs obtained from the common field, the stream index number of the user-specific subfield, and the stream allocation value obtained from the user-specific subfield to determine the stream allocation for the STA. In some embodiments, the lookup table may be based on the constraint that the number of stream allocations for the STAs in the user-specific subfields of the HE SIG-B field increase with increasing stream index number or are equal to the previous stream index number. In some embodiments, the lookup table may be based on the constraint that the number of stream allocations for the STAs in the user-specific subfields of the HE SIG-B field decrease with increasing stream index number or are equal to the next stream index number. Thus, in these embodiments whether increasing or decreasing the number of stream allocations for the STAs in the user-specific subfields of the HE SIG-B field monotonically change with increasing stream index number. In some embodiments, the stream allocations may start from the first channel and increase in a contiguous manner. In some embodiments, the stream allocations may start from the first channel and increase in a contiguous manner until the last stream allocation, which may start from the last channel, thereby potentially providing a non-contiguous stream allocation in which channels between the channels assigned to the last STA and to the next to last STA may remain unallocated to any STA in the BSS. In some embodiments, the stream allocations may start from the last channel and decrease in a contiguous manner. In some embodiments, the stream allocations may start from the last channel and increase in a contiguous manner until the last stream allocation, which may start from the last channel. In some embodiments, different lookup tables may be present, with the lookup table used being signaled in the common field of the HE SIG-B field or the HE SIG-A field, for example. Use of the lookup table may permit the stream allocation of the STA to be determined by a 3-bit stream allocation value so long as the maximum number of stream allocations is 8 (160 MHz).

At operation 610, having obtained the stream allocation from the lookup table, the STA may communicate using the stream allocation. The STA may communicate with the AP using 1-8 channels of 20 MHz/channel (i.e., 20-160 MHz). Each channel in the stream allocation may be a SU, MU-MIMO or OFDMA transmission.

### EXAMPLES

Example 1 is an apparatus of a high-efficiency (HE) station (STA) comprising: a transceiver; and processing circuitry arranged to: configure the transceiver to receive a HE Physical Layer Convergence Protocol Data Unit (HE PPDU) from an access point (AP), the HE PPDU comprising a HE preamble, the HE preamble comprising a HE signal B (HE SIG-B) field comprising a user-specific subfield, the user-specific subfield comprising a stream allocation value associated with the STA, the user-specific subfield disposed in a position within the HE SIG-B field indicated by a stream index number; determine a channel to use in communication with the AP based on the stream allocation value and the stream index number; and configure the transceiver to communicate with the AP using the channel determined from the stream allocation value and the stream index number.

In Example 2, the subject matter of Example 1 optionally includes that the processing circuitry is arranged to determine the channel further based on a total number of user-specific subfields in the HE SIG-B field.

In Example 3, the subject matter of Example 2 optionally includes that at least one of: the HE SIG-B field comprises common information indicating a resource unit (RU) allocation, and the HE preamble comprises a HE SIG-A field disposed before the HE SIG-B field, the HE SIG-A field configured to provide common control information to decode the HE SIG-B field, the common control information decodable by STAs comprising the total number of symbols in the HE SIG-B field.

In Example 4, the subject matter of any one or more of Examples 1-3 optionally include that the HE SIG-B field comprises a plurality of user-specific subfields each associated with a different STA and having a unique stream index number indicating a position among the user-specific subfields, each user-specific subfield comprising a number of channels allocated to the associated STA, the HE preamble comprises a HE SIG-A field disposed before the HE SIG-B field, the stream index numbers increase with increasing position of the associated user-specific subfield from the HE SIG-B field, and the number of channels allocated in each user-specific subfield is constrained to one of stay the same and increase with increasing stream index number.

In Example 5, the subject matter of any one or more of Examples 1-4 optionally include that the HE SIG-B field comprises a plurality of user-specific subfields each associated with a different STA and having a unique stream index number indicating a position within the HE SIG-B field, each user-specific subfield comprising a number of channels allocated to the associated STA, the HE preamble comprises a HE SIG-A field disposed before the HE SIG-B field, the stream index numbers increase with increasing position of the associated user-specific subfield from the HE SIG-B field, and the number of channels allocated in each user-specific subfield is constrained to one of stay the same and decrease with increasing stream index number.

In Example 6, the subject matter of any one or more of Examples 1-5 optionally include that the HE SIG-B field comprises a plurality of user-specific subfields each associated with a different STA, and channels are allocated contiguously by stream allocation values in the user-specific subfields such that each channel is allocated to one of the STAs.

In Example 7, the subject matter of any one or more of Examples 1-6 optionally include that the HE SIG-B field comprises a plurality of user-specific subfields each associated with a different STA, and channels are allocated non-contiguously by stream allocation values in the user-specific subfields such that at least one channel is free from allocation to the STAs.

In Example 8, the subject matter of Example 7 optionally includes that the stream allocation values in the user-specific subfields other than a final user-specific subfield indicate an allocation to increasing channels and in the final user-specific subfield indicate an allocation to at least one channel starting from a final channel.

In Example 9, the subject matter of any one or more of Examples 7-8 optionally include that the stream allocation values in the user-specific subfields other than a final user-specific subfield indicate an allocation to decreasing channels and in the final user-specific subfield indicate an allocation to at least one channel starting from an initial channel.

In Example 10, the subject matter of any one or more of Examples 1-9 optionally include that the HE SIG-B field comprises: a plurality of user-specific subfields, each user-specific subfield comprising a particular stream allocation value associated with a different STA, the stream allocation values using a same number of bits, a channel allocation of the STAs having a same stream allocation value being different dependent on an order of the user-specific subfield within the HE SIG-B field, and a common subfield disposed before the user-specific subfields, the common subfield comprising a spatial stream allocation for each allocated resource unit.

In Example 11, the subject matter of any one or more of Examples 1-10 optionally include that the stream allocation value is a 3 bit number.

In Example 12, the subject matter of any one or more of Examples 1-11 optionally include, further comprising an antenna configured to transmit and receive communications between the transceiver and the AP.

Example 13 is an apparatus of an access point (AP) comprising: a transceiver arranged to communicate with a plurality of stations (STAs); and processing circuitry arranged to: select a channel allocation for each of the plurality of STAs; for each channel allocation, determine a stream allocation value indicating the channel allocation and encode the stream allocation value dependent on a STA associated with the channel allocation to form an encoded stream allocation value; generate a high-efficiency Physical Layer Convergence Protocol Data Unit (HE PPDU) comprising a HE preamble, the HE preamble comprising a HE SIG-B field, the HE SIG-B field comprising a plurality of user-specific subfields, each user-specific subfield comprising an encoded stream allocation value for an associated STA and associated with a unique stream index number that indicates a position of the user-specific subfield among the user-specific subfields, each stream allocation value dependent on channels allocated by the stream allocation value, a stream index number of the user-specific subfield in which the stream allocation value is disposed and a number of user-specific subfields; configure the transceiver to transmit to the STAs the HE PPDU; and configure the transceiver to communicate with the STAs based on the channels allocated in the HE SIG-B.

In Example 14, the subject matter of Example 13 optionally includes that at least one of: the HE SIG-B field comprises common information indicating a resource unit (RU allocation), and the HE preamble comprises a HE SIG-A field disposed before the HE SIG-B field, the HE SIG-A field configured to provide common control information to decode the HE SIG-B field, the common control information decodable by the plurality of STAs comprising a total number of symbols in the HE SIG-B field.

In Example 15, the subject matter of any one or more of Examples 13-14 optionally include that the HE preamble comprises a HE SIG-A field disposed before the HE SIG-B field, the stream index numbers increase with increasing position of the associated user-specific subfield from the HE SIG-B field, and a number of channels allocated in each user-specific subfield is constrained to one of stay the same and increase with increasing stream index number.

In Example 16, the subject matter of any one or more of Examples 13-15 optionally include that the HE preamble comprises a HE SIG-A field disposed before the HE SIG-B field, the stream index numbers increase with increasing position of the associated user-specific subfield from the HE SIG-B field, and the number of channels allocated in each user-specific subfield is constrained to one of stay the same and decrease with increasing stream index number.

In Example 17, the subject matter of any one or more of Examples 13-16 optionally include that the channels are allocated contiguously by the stream allocation values in the user-specific subfields such that each channel is allocated to one of the plurality of STAs.

In Example 18, the subject matter of any one or more of Examples 13-17 optionally include that the channels are allocated non-contiguously by the stream allocation values in the user-specific subfields such that at least one channel is free from allocation to the plurality of STAs.

In Example 19, the subject matter of Example 18 optionally includes that one of: the stream allocation values in the user-specific subfields other than a final user-specific subfield indicate an allocation to increasing channels and in the final user-specific subfield indicate an allocation to at least one channel starting from a final channel, and the stream allocation values in the user-specific subfields other than the final user-specific subfield indicate an allocation to decreasing channels and in the final user-specific subfield indicate an allocation to at least one channel starting from an initial channel.

In Example 20, the subject matter of any one or more of Examples 13-19 optionally include that each stream allocation value is a 3 bit number.

Example 21 is a non-transitory computer-readable storage medium that stores instructions for execution by one or more processors of a station (STA), the one or more processors to configure the STA to: receive a high-efficiency Physical Layer Convergence Protocol Data Unit (HE PPDU) from an access point (AP), the HE PPDU comprising a HE preamble, the HE preamble comprising a HE SIG-B field, the HE SIG-B field comprising a plurality of user-specific subfields, each user-specific subfield comprising an encoded stream allocation value for an associated STA and associated with a unique stream index number that indicates a position of the user-specific subfield among the user-specific subfields; in response to a determination that a resource allocation for the STA is present in one of the user-specific subfields, decode one stream allocation value in the one of the user-specific subfields associated with the resource allocation for the STA; determine, from the one stream allocation value, a stream index number of the user-specific subfield in which the one stream allocation value is disposed and a number of user-specific subfields, at least one channel allocated to the STA; and communicate with the AP using the at least one channel based on the determination of the one stream allocation value.

In Example 22, the subject matter of Example 21 optionally includes that the HE preamble comprises a HE SIG-A field disposed before the HE SIG-B field, the stream index numbers increase with increasing position of the associated user-specific subfield from the HE SIG-B field, and a number of channels allocated in each user-specific subfield is constrained to one of stay the same and monotonically change with increasing stream index number.

In Example 23, the subject matter of any one or more of Examples 21-22 optionally include that the channels are allocated non-contiguously by the stream allocation values in the user-specific subfields such that at least one channel is free from allocation to a STA, and one of: the stream allocation values in the user-specific subfields other than a final user-specific subfield indicate an allocation to increasing channels and in the final user-specific subframe indicate an allocation to at least one channel starting from a final channel, and the stream allocation values in the user-specific subfields other than the final user-specific subfield indicate an allocation to decreasing channels and in the final user-specific subframe indicate an allocation to at least one channel starting from an initial channel.

Example 24 is a method for communicating high-efficiency Physical Layer Convergence Protocol Data Units (HE PPDUs) performed by an HE STA station (STA), the method comprising: receiving a HE PPDU from an access point (AP), the HE PPDU comprising a HE preamble, the HE preamble comprising a HE SIG-A field followed by a HE SIG-B field, the HE SIG-B field comprising a plurality of user-specific subfields, each user-specific subfield comprising an encoded stream allocation value for an associated STA and associated with a unique stream index number that indicates a position of the user-specific subfield among the user-specific subfields, the stream index numbers increase with increasing position of the associated user-specific subfield from the HE SIG-B field, a number of channels allocated in each user-specific subfield is constrained to one of stay the same and monotonically change with increasing stream index number; in response to a determination that a resource allocation for the STA is present in one of the user-specific subfields, decoding one stream allocation value in the one of the user-specific subfields associated with the resource allocation for the STA; determining, from the one stream allocation value, a stream index number of the user-specific subfield in which the one stream allocation value is disposed and a number of user-specific subfields, at least one channel allocated to the STA; and communicating with the AP using the at least one channel based on the determination of the one stream allocation value.

In Example 25, the subject matter of Example 24 optionally includes that the channels are allocated non-contiguously by the stream allocation values in the user-specific subfields such that at least one channel is free from allocation to a STA, and one of: the stream allocation values in the user-specific subfields other than a final user-specific subfield indicate an allocation to increasing channels and in the final user-specific subframe indicate an allocation to at least one channel starting from a final channel, and the stream allocation values in the user-specific subfields other than the final user-specific subfield indicate an allocation to decreasing channels and in the final user-specific subframe indicate an allocation to at least one channel starting from an initial channel.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

1. An apparatus of a high-efficiency (HE) station (STA) comprising:
a transceiver; and
processing circuitry arranged to:
configure the transceiver to receive a HE Physical Layer Convergence Protocol Data Unit (HE PPDU) from an access point (AP), the HE PPDU comprising a HE preamble, the HE preamble comprising a HE signal B (HE SIG-B) field comprising a user-specific subfield, the user-specific subfield comprising a stream allocation value associated with the STA, the user-specific subfield disposed in a position within the HE SIG-B field indicated by a stream index number;
determine a channel to use in communication with the AP based on the stream allocation value and the stream index number; and
configure the transceiver to communicate with the AP using the channel determined from the stream allocation value and the stream index number.

2. The apparatus of claim 1 wherein:
the processing circuitry is arranged to determine the channel further based on a total number of user-specific subfields in the HE SIG-B field.

3. The apparatus of claim 2 wherein:
at least one of:
the HE SIG-B field comprises common information indicating a resource unit (RU) allocation, and
the HE preamble comprises a HE SIG-A field disposed before the HE SIG-B field, the HE SIG-A field configured to provide common control information to decode the HE SIG-B field, the common control information decodable by STAs comprising the total number of symbols in the HE SIG-B field.

4. The apparatus of claim 1 wherein:
the HE SIG-B field comprises a plurality of user-specific subfields each associated with a different STA and having a unique stream index number indicating a position among the user-specific subfields, each user-specific subfield comprising a number of channels allocated to the associated STA,
the HE preamble comprises a HE SIG-A field disposed before the HE SIG-B field,
the stream index numbers increase with increasing position of the associated user-specific subfield from the HE SIG-B field, and
the number of channels allocated in each user-specific subfield is constrained to one of stay the same and increase with increasing stream index number.

5. The apparatus of claim 1 wherein:
the HE SIG-B field comprises a plurality of user-specific subfields each associated with a different STA and having a unique stream index number indicating a position within the HE SIG-B field, each user-specific subfield comprising a number of channels allocated to the associated STA,
the HE preamble comprises a HE SIG-A field disposed before the HE SIG-B field,
the stream index numbers increase with increasing position of the associated user-specific subfield from the HE SIG-B field, and
the number of channels allocated in each user-specific subfield is constrained to one of stay the same and decrease with increasing stream index number.

6. The apparatus of claim 1 wherein:
the HE SIG-B field comprises a plurality of user-specific subfields each associated with a different STA, and channels are allocated contiguously by stream allocation values in the user-specific subfields such that each channel is allocated to one of the STAs.

7. The apparatus of claim 1 wherein:
the HE SIG-B field comprises a plurality of user-specific subfields each associated with a different STA, and channels are allocated non-contiguously by stream allocation values in the user-specific subfields such that at least one channel is free from allocation to the STAs.

8. The apparatus of claim 7 wherein:
the stream allocation values in the user-specific subfields other than a final user-specific subfield indicate an allocation to increasing channels and in the final user-specific subfield indicate an allocation to at least one channel starting from a final channel.

9. The apparatus of claim 7 wherein:
the stream allocation values in the user-specific subfields other than a final user-specific subfield indicate an allocation to decreasing channels and in the final user-specific subfield indicate an allocation to at least one channel starting from an initial channel.

10. The apparatus of claim 1 wherein the HE SIG-B field comprises:
a plurality of user-specific subfields, each user-specific subfield comprising a particular stream allocation value associated with a different STA, the stream allocation values using a same number of bits, a channel allocation of the STAs having a same stream allocation value being different dependent on an order of the user-specific subfield within the HE SIG-B field, and
a common subfield disposed before the user-specific subfields, the common subfield comprising a spatial stream allocation for each allocated resource unit.

11. The apparatus of claim 1 wherein:
the stream allocation value is a 3 bit number.

12. The apparatus of claim 1, further comprising an antenna configured to transmit and receive communications between the transceiver and the AP.

13. An apparatus of an access point (AP) comprising:
a transceiver arranged to communicate with a plurality of stations (STAs); and
processing circuitry arranged to:
select a channel allocation for each of the plurality of STAs;
for each channel allocation, determine a stream allocation value indicating the channel allocation and encode the stream allocation value dependent on a STA associated with the channel allocation to form an encoded stream allocation value;
generate a high-efficiency Physical Layer Convergence Protocol Data Unit (HE PPDU) comprising a HE preamble, the HE preamble comprising a HE SIG-B field, the HE SIG-B field comprising a plurality of user-specific subfields, each user-specific subfield comprising an encoded stream allocation value for an associated STA and associated with a unique stream index number that indicates a position of the user-specific subfield among the user-specific subfields, each stream allocation value dependent on channels allocated by the stream allocation value, a stream index number of the user-specific subfield in which the stream allocation value is disposed and a number of user-specific subfields;
configure the transceiver to transmit to the STAs the HE PPDU; and
configure the transceiver to communicate with the STAs based on the channels allocated in the HE SIG-B.

14. The apparatus of claim 13 wherein:
at least one of:
the HE SIG-B field comprises common information indicating a resource unit (RU allocation), and
the HE preamble comprises a HE SIG-A field disposed before the HE SIG-B field, the HE SIG-A field configured to provide common control information to decode the HE SIG-B field, the common control information decodable by the plurality of STAs comprising a total number of symbols in the HE SIG-B field.

15. The apparatus of claim 13 wherein:
the HE preamble comprises a HE SIG-A field disposed before the HE SIG-B field,
the stream index numbers increase with increasing position of the associated user-specific subfield from the HE SIG-B field, and
a number of channels allocated in each user-specific subfield is constrained to one of stay the same and increase with increasing stream index number.

16. The apparatus of claim 13 wherein:
the HE preamble comprises a HE SIG-A field disposed before the HE SIG-B field,
the stream index numbers increase with increasing position of the associated user-specific subfield from the HE SIG-B field, and
the number of channels allocated in each user-specific subfield is constrained to one of stay the same and decrease with increasing stream index number.

17. The apparatus of claim 13 wherein:
the channels are allocated contiguously by the stream allocation values in the user-specific subfields such that each channel is allocated to one of the plurality of STAs.

18. The apparatus of claim 13 wherein:
the channels are allocated non-contiguously by the stream allocation values in the user-specific subfields such that at least one channel is free from allocation to the plurality of STAs.

19. The apparatus of claim 18 wherein one of:
the stream allocation values in the user-specific subfields other than a final user-specific subfield indicate an allocation to increasing channels and in the final user-specific subfield indicate an allocation to at least one channel starting from a final channel, and
the stream allocation values in the user-specific subfields other than the final user-specific subfield indicate an allocation to decreasing channels and in the final user-specific subfield indicate an allocation to at least one channel starting from an initial channel.

20. The apparatus of claim 13 wherein:
each stream allocation value is a 3 bit number.

21. A non-transitory computer-readable storage medium that stores instructions for execution by one or more processors of a station (STA), the one or more processors to configure the STA to:
receive a high-efficiency Physical Layer Convergence Protocol Data Unit (HE PPDU) from an access point (AP), the HE PPDU comprising a HE preamble, the HE preamble comprising a HE SIG-B field, the HE SIG-B field comprising a plurality of user-specific subfields, each user-specific subfield comprising an encoded stream allocation value for an associated STA and associated with a unique stream index number that indicates a position of the user-specific subfield among the user-specific subfields;
in response to a determination that a resource allocation for the STA is present in one of the user-specific subfields, decode one stream allocation value in the one of the user-specific subfields associated with the resource allocation for the STA;
determine, from the one stream allocation value, a stream index number of the user-specific subfield in which the one stream allocation value is disposed and a number of user-specific subfields, at least one channel allocated to the STA; and
communicate with the AP using the at least one channel based on the determination of the one stream allocation value.

22. The medium of claim 21 wherein:
the HE preamble comprises a HE SIG-A field disposed before the HE SIG-B field,
the stream index numbers increase with increasing position of the associated user-specific subfield from the HE SIG-B field, and
a number of channels allocated in each user-specific subfield is constrained to one of stay the same and monotonically change with increasing stream index number.

23. The medium of claim 21 wherein:
the channels are allocated non-contiguously by the stream allocation values in the user-specific subfields such that at least one channel is free from allocation to a STA, and one of:
the stream allocation values in the user-specific subfields other than a final user-specific subfield indicate an allocation to increasing channels and in the final user-specific subframe indicate an allocation to at least one channel starting from a final channel, and
the stream allocation values in the user-specific subfields other than the final user-specific subfield indicate an allocation to decreasing channels and in the final user-specific subframe indicate an allocation to at least one channel starting from an initial channel.

24. A method for communicating high-efficiency Physical Layer Convergence Protocol Data Units (HE PPDUs) performed by an HE STA station (STA), the method comprising:
receiving a HE PPDU from an access point (AP), the HE PPDU comprising a HE preamble, the HE preamble comprising a HE SIG-A field followed by a HE SIG-B field, the HE SIG-B field comprising a plurality of user-specific subfields, each user-specific subfield comprising an encoded stream allocation value for an associated STA and associated with a unique stream index number that indicates a position of the user-specific subfield among the user-specific subfields, the stream index numbers increase with increasing position of the associated user-specific subfield from the HE SIG-B field, a number of channels allocated in each user-specific subfield is constrained to one of stay the same and monotonically change with increasing stream index number;
in response to a determination that a resource allocation for the STA is present in one of the user-specific subfields, decoding one stream allocation value in the one of the user-specific subfields associated with the resource allocation for the STA;
determining, from the one stream allocation value, a stream index number of the user-specific subfield in which the one stream allocation value is disposed and a number of user-specific subfields, at least one channel allocated to the STA; and
communicating with the AP using the at least one channel based on the determination of the one stream allocation value.

25. The method of claim 24 wherein:
the channels are allocated non-contiguously by the stream allocation values in the user-specific subfields such that at least one channel is free from allocation to a STA, and one of:
the stream allocation values in the user-specific subfields other than a final user-specific subfield indicate an allocation to increasing channels and in the final user-specific subframe indicate an allocation to at least one channel starting from a final channel, and
the stream allocation values in the user-specific subfields other than the final user-specific subfield indicate an allocation to decreasing channels and in the final user-specific subframe indicate an allocation to at least one channel starting from an initial channel.
